(19) United States
(12) Patent Application Publication
(10) Pub. No.: US 2013/0171054 A1
(43) Pub. Date: Jul. 4, 2013

(54) Supported Catalyst for Synthesizing Multi-Wall Carbon Nanotubes and Method for Preparing the Same

(71) Applicant: Cheil Industries Inc., Gumi-si (KR)

(72) Inventors: Byeong Yeol Kim, Seongnam-si (KR); Yun Tack Lee, Seoul-si (KR); Sung Hee Ahn, Seoul-si (KR); Seung Young Bae, Gunpo-si (KR)

(73) Assignee: Cheil Industries Inc., Gumi-si (KR)

(21) Appl. No.: 13/715,019

(22) Filed: Dec. 14, 2012

(30) Foreign Application Priority Data
Dec. 31, 2011 (KR) 10-2011-0148008

(51) Int. Cl. C01B 31/02; C01B 31/00; B01J 23/889

(52) U.S. Cl. CPC C01B 31/0233; B01J 23/8898; C01B 31/00; Y10S 977/752; Y10S 977/843; B82Y 40/00
USPC 423/447.2; 502/324; 502/314; 423/447.3; 977/752; 977/843

(57) ABSTRACT

A supported catalyst for synthesizing multi-walled carbon nanotubes includes a supporting body and a metal catalyst including Fe, Co, and Mn in a mole ratio according to Equation (1):

Fe:Co:Mn=1:x:y (1)

wherein 2.0≦x≦4.0 and 0.01≦y≦5.00. The supported catalyst can be prepared by dissolving the metal catalysts into a solvent to prepare an aqueous solution of the metal catalysts; dissolving supporting body materials into a solvent to prepare an aqueous solution of the supporting body material; mixing the aqueous solutions and heating the mixed solution at temperature of about 100° to about 800° C. under normal atmospheric pressure for about 10 to about 40 min. Multi-walled carbon nanotubes can be prepared by placing the supported catalyst in chemical vapor deposition (TCVD) equipment and feeding hydrocarbon gas and hydrogen gas at a temperature of about 650° to about 1,100° C. under normal atmospheric pressure.

### CROSS-REFERENCE TO RELATED APPLICATION

This application claims priority under 35 USC Section 119 to and the benefit of Korea Patent Application No. 10-2011-0148008 filed Dec. 31, 2011, in the Korean Intellectual Property Office, the disclosure of which is incorporated herein by reference in its entirety.

### FIELD OF INVENTION

This invention relates to a support catalyst for synthesizing multi-walled carbon nanotubes and methods for preparing nanotubes.

### BACKGROUND OF INVENTION

Carbon nanotubes discovered by Iijima in 1991 have hexagon honeycomb structures connecting one carbon atom with three other neighboring carbon atoms. This hexagon structure is repeated and rolled into a cylindrical or tube form.

Carbon nanotubes have excellent mechanical characteristics, electrical selectivity, and field emission properties and have been proposed for use in polymer composites. Accordingly, since their discovery, carbon nanotubes have been the subject of numerous publications and research efforts focused in the development of industrial and commercial applications for the same.

Carbon nanotubes can be manufactured using various processes such as arc discharge, laser ablation, chemical vapor deposition and the like. Carbon nanotubes can be categorized as single-wall, double-wall and multi-wall carbon nanotubes according to their shape. However, these various synthesis methods can be expensive, and can be limited with regard to the production of high purity carbon nanotubes in high yields.

Carbon nanotubes can be used with engineering plastics to form composites with properties such as electromagnetic wave shielding, antistatic properties, and electrical conductivity. A small amount of carbon nanotubes can be used to provide electrical conductivity, but the results can depend on process conditions, the resin used, and the electrical characteristics of the carbon nanotubes used.

Generally, multi-walled carbon nanotubes are used for applications in plastic composites. Multi-wall nanotubes, however, can have inferior electrical properties due to amorphous carbon or defects on the surface formed during synthesis. Accordingly, a composite including the same may not have the desired electrical property.

Thus it can be important to improve the crystallinity of the surface of the carbon nanotubes. One method re-aligns the hexagon structure of carbon atoms using a high temperature treatment to improve surface crystallinity of carbon nanotubes. This method, however, increases manufacturing cost because an additional process is required after carbon nanotube synthesis. It can also be difficult to select synthesis conditions for the high heat treatment. In addition, productivity can be impaired.

### SUMMARY OF THE INVENTION

The inventors of the present invention have developed a new supported catalyst for the synthesis of carbon nanotubes. The supported catalyst can improve the surface characteristics of carbon nanotubes. The invention further provides multi-walled carbon nanotubes synthesized using the supported catalyst. The multi-walled carbon nanotubes can have improved properties such as surface crystallinity, electrical conductivity and yields produced.

In exemplary embodiments, the supported catalyst for synthesizing multi-walled carbon nanotubes includes a supporting body and a metal catalyst supported on the supporting body, wherein the metal catalyst includes iron (Fe), cobalt (Co), and manganese (Mn) in a mole ratio according to equation (1) below:

Fe:Co:Mn=1:x:y (1)

wherein x and y are mole ratios, and 2.0≦x≦4.0 and 0.01≦y≦5.0.

In other exemplary embodiments, the supported catalyst for synthesizing multi-walled carbon nanotubes includes a supporting body and a metal catalyst supported on the supporting body, wherein the metal catalyst includes Fe, Co, Mn, and molybdenum (Mo) in a mole ratio according to equation (2) below:

Fe:Co:Mn:Mo=1:x:y:z (2)

wherein x, y, and z are mole ratios and 2.0≦x≦4.0, 0.01≦y≦5.0 and 0≦z≦2.0.

The supported catalysts of the aforesaid Equation (1) and Equation (2) can include metal catalysts comprising Fe, Co, and Mn in the form of hydrates.

The supporting body can include alumina (aluminum oxide, Al₂O₃), magnesium oxide (MgO), silica (silicon dioxide, SiO₂) and combinations thereof.

In exemplary embodiments, the supported catalysts for synthesizing multi-walled carbon nanotubes include a supporting body and a metal catalyst supported on the supporting body comprising Fe, Co, Mn, Mo, and vanadium (V) in a mole ratio according to equation (3) below:

(Fe,Co,Mn)x(Mo,V)y(Al₂O₃,MgO,SiO₂)z (3)

wherein x, y, and z are mole ratios and 1≦x≦10, 0≦y≦5, and 1≦z≦20.

As used herein, “(Fe, Co, Mn)” refers to at least one catalyst selected from Fe, Co, and Mn; “(Mo, V)” refers to at least one catalyst selected from Mo and V; and “(Al₂O₃, MgO, SiO₂)” refers to at least one supporting body material selected from Al₂O₃, MgO, and SiO₂.

Examples of the supporting body material in the aforesaid Equation (3) include without limitation alumina (Al₂O₃), magnesium oxide (MgO), silicon dioxide (SiO₂), and combinations thereof.

The supported catalysts in accordance with this invention can be solid spherical structures, and can have an average diameter of about 20 to about 100 μm and a flatness ratio about 0 to about 0.2.

The supported catalyst for synthesizing multi-walled carbon nanotubes in accordance with this invention can be prepared by dissolving the metal catalyst into a solvent to prepare a metal catalyst aqueous solution; dissolving supporting body material such as aluminum oxide, magnesium oxide, and/or silicon dioxide into a solvent to prepare an aqueous solution of the supporting body material; mixing the aqueous solution of the metal catalysts and the aqueous solution of the supporting body material; and then heating the mixture for about 10 to about 40 minutes at a temperature of about 100 to about 800° C. under normal pressure.

To synthesis carbon nanotubes, the aforesaid prepared supported catalyst can be positioned inside thermal chemical vapor deposition (TCVD) equipment, and multi-walled carbon nanotubes can be prepared by feeding hydrocarbon gas and hydrogen gas at a temperature of about 650 to about 1,100° C. at normal atmosphere.

The supported catalysts of the invention can allow the production of carbon nanotubes having improved physical properties such as surface crystallinity and/or electrical conductivity. The supported catalysts can also provide improved yields of multi-walled carbon nanotubes.

### DETAILED DESCRIPTION

The present invention will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

This invention relates to supported catalysts for synthesizing multi-walled carbon nanotubes that can have excellent surface crystallinity and multi-walled carbon nanotubes prepared using the same.

Supported Catalysts for the Synthesis of Multi-Wall Carbon Nanotubes

The electrical property of multi-wall carbon nanotubes can be impaired due to amorphous carbon or surface defects that are developed during the course of the synthesis. As a result, using the multi-wall carbon nanotubes in a composite may not provide the desired electrical characteristics.

To solve these problems, this invention provides a new supported catalyst in which manganese (Mn) is introduced to provide excellent surface crystallinity in a multi-walled carbon nanotube.

To synthesize the multi-walled carbon nanotubes with excellent surface crystallinity, the supported catalyst in accordance with this invention includes a support body and metal catalysts comprising Fe, Co, and Mn supported on the supporting body (for example an oxide supporting body). In exemplary embodiments, the supported catalyst can have a solid spherical structure and can have metal catalysts in the form of a plurality of metal catalyst particles distributed across an outer surface of the supporting body. Also in exemplary embodiments, a plurality of metal catalyst particles can be distributed in (along) an inner part of the supporting body.

Examples of oxides useful for the supporting body include without limitation aluminum oxide, magnesium oxide, silica (silicon dioxide) and the like, and combinations thereof.

The aforesaid solid spherical structure refers to internally filled spherical structures. In exemplary embodiments, the spherical structure can have a substantially spherical shape. In other exemplary embodiments, the spherical structure can have an oval shape. The solid spherical structure can have an average diameter of about 20 to about 100 μm and a degree of flatness greater than about 0 and smaller than about 0.2.

In exemplary embodiments, the supported catalyst includes a supporting body and metal catalysts comprising Fe, Co, and Mn supported on the supporting body in a mole ratio according to equation (1) below:

Fe:Co:Mn=1:x:y (1)

wherein x and y are mole ratios and 2.0≦x≦4.0 and 0.01≦y≦5.0.

In other exemplary embodiments, the supported catalyst includes a supporting body and metal catalysts comprising Fe, Co, Mn, and Mo supported on the supporting body in a mole ratio according to equation (2) below:

Fe:Co:Mn:Mo=1:x:y:z (2)

wherein x, y, and z mole ratios and 2.0≦x≦4.0, 0.01≦y≦5.0, and 0≦z≦2.0.

Examples of the metal catalysts include without limitation Fe(NO₃), Co(NO₃)₂, Fe(OAc)₂, Co(OAc)₂, Mn(NO₃)₂.6H₂O (manganese (II) nitrate hexahydrate), and the like, and combinations thereof. In exemplary embodiments, hydrates of the metal catalysts, such as but not limited to iron (III) nitrate nonahydrate, cobalt nitrate nonahydrate, and the like, and combinations thereof, can also be used. Ni(NO₃)₂ or Ni(OAc)₂ can also be added to the metal catalysts.

In exemplary embodiments, the metal catalysts in the aforesaid Equation (1) and Equation (2) are in the hydrate forms of Fe, Co, and Mn.

In exemplary embodiments, Al₂O₃, MgO, and/or SiO₂ can be used as the supporting body material. Aluminum nitrate nonahydrate can also be used as a supporting body.

The metal catalysts and supporting body material can be dissolved into a suitable solvent, such as water, alcohol, or a combination thereof, to make aqueous solutions.

In exemplary embodiments, an activator, such as molybdenum (Mo), can be added during the sintering process at high temperatures to minimize or prevent aggregation between nano-sized metal catalysts. In other exemplary embodiments, an activator such as citric acid can be used.

In exemplary embodiments, composite catalysts in which water soluble polymers are dissolved can be manufactured as spherical particles by means of heat treatment.

In other exemplary embodiments, the supported catalysts include a supporting body and metal catalysts including Fe, Co, Mn, Mo, and V supported on the supporting body in a mole ratio according to equation (3) below:

(Fe,Co,Mn)ₓ(Mo,V)_{y}(Al₂O₃,MgO,SiO₂)_{z} (3)

wherein x, y, and z are mole ratios and 1≦x≦10, 0≦y≦5, and 1≦z≦20.

As used herein, “(Fe, Co, Mn)” refers to at least one catalyst selected from Fe, Co, and Mn; “(Mo, V)” refers to at least one catalyst selected from Mo and V; and “(Al₂O₃, MgO, SiO₂)” refers to at least one supporting body material selected from Al₂O₃, MgO, and SiO₂. Combinations of the noted catalysts and/or supporting body materials can also be used

In Equation (3), alumina (Al₂O₃), magnesium oxide (MgO), or silicon dioxide (SiO₂) can be used, or a combination of more than two of these can be used.

Preparation of the Supported Catalyst

The supported catalyst for synthesizing carbon nanotubes in accordance with this invention can be prepared by steps including: preparing an aqueous solution of the metal catalyst by dissolving the metal catalyst into a solvent; preparing an aqueous solution of the supporting body material by dissolving a supporting body material such as aluminum oxide, magnesium oxide, and/or silicon dioxide into a solvent; mixing the aforesaid aqueous solution of the metal catalyst with the aforesaid aqueous solution of the supporting body material; and then synthesizing the supported catalyst by heat treatment (heating the mixed solution) at a temperature of about 100 to about 800° C. under normal pressure for about 10 to about 40 minutes.

Catalyst powders can be prepared by heating the mixture of the aqueous solution of the catalyst and the aqueous solution of the supporting body materials (the mixture also referred to herein as the solution of the catalyst composition) to form catalyst powders; and burning (firing or sintering) the catalyst powders.

Examples of materials useful for forming the supporting body include without limitation aluminum nitrate, magnesium oxide, silica, and the like, and combinations thereof.

Synthesis of the Multi-Walled Carbon Nanotubes

Multi-wall carbon nanotubes can be synthesized using conventional thermal chemical vapor deposition (TCVD) methods as known in the art. The prepared supported catalysts can be positioned inside TCVD equipment, and multi-wall carbon nanotubes can be prepared by feeding hydrocarbon and hydrogen gas at a temperature of about 650 to about 1,100° C. under normal atmospheric pressure.

For example, the supported catalyst can be placed in a ceramic boat and left inside the TCVD equipment, and multi-walled carbon nanotubes can be prepared by feeding hydrocarbon gas in the presence of the supported catalyst at a temperature of about 650 to about 1,100° C. under normal atmospheric pressure, for example a temperature of about 670 to about 950° C.

Examples of the hydrocarbon gas include without limitation methane, ethylene, acetylene, LPG, and the like, and combinations thereof. Hydrogen gas can be fed along with the hydrocarbon gas.

The hydrogen gas can prevent decomposition of the carbon nanotubes that can occur at high temperatures by reducing oxygen that is attached to the catalysts.

The hydrocarbon gas and hydrogen gas can be supplied for a period of time of about 20 minutes to about 70 hours, for example about 30 minutes to about 1 hour.

Each of the hydrocarbon and hydrogen gas can be supplied at a rate of about 80 to about 300 sccm respectively.

This invention provides multi-walled carbon nanotubes that can have excellent surface crystallinity using the supported catalysts. The degree of surface crystallinity of multi-wall carbon nanotubes can be judged objectively by measuring the strength ratio (ID/IG) of Raman spectroscopy.

This invention will now be described in more detail with reference to the following examples. The following examples are not intended to limit or restrict the scope of protection of this invention.

### EXAMPLES

### Example 1

Specified amounts of the metal catalysts, hydrate of ferric nitrate (III), cobalt hydrate, and manganese hydrate, are dissolved in 20 ml of water to prepare aqueous solutions of the metal catalysts. Aluminum nitrate nonahydrate and activator citric acid are dissolved as supporting body materials in 150 ml of water, and then this aqueous solution is mixed with the aqueous solution of the metal catalysts to prepare a solution of the catalyst composition. The solution of the catalyst composition is heat treated at 550° C. under normal atmospheric pressure for 35 min. to prepare a supported catalyst. 0.03 g of the prepared supported catalyst is placed into a ceramic boat and the boat is placed inside TCVD fixed bed synthesis equipment at 700° C. under normal atmospheric pressure for 1 hour, while C₂H₄/H₂ at 100/100 sccm is passed through the system to prepare the carbon nanotubes.

The metal catalysts (Fe, Co, Mo, and Mn) are used in a composition ratio as given in Table 1 below, and the metal catalyst and the supporting body are used in a mole ratio of 1:12.

The surface crystallinity of the multi-wall carbon nanotubes synthesized by the process is analyzed by Raman spectroscopy as discussed in more detail below, and the results are set forth in Table 1.

### Examples 2 to 3 and Comparative Examples 1 to 2

A supported catalyst is prepared using the same method as in Example 1 except that the metal catalyst composition is as shown in table 1 below, and then the carbon nanotubes are synthesized.

The surface crystallinity of the synthesized multi-walled carbon nanotubes is also analyzed through Raman analysis, and the results are presented in Table 1.

Raman Analysis

The Raman spectroscopic analysis is the result of three (3) repetitions with the following measurement conditions:

| Category | Condition of Measurement | |
|---|---|---|
| Laser | 514 | nm |
| Grating | 2400 | L/mm |
| Exposure time | 10 | sec. |
| Accumulations | 3 | |
| Measurement zone | 100~3200 | cm⁻¹ |

Method of Measurement of the Surface Resistance

100 mg of carbon nanotube powder is placed inside a metal mold with a diameter of 10 mm and a height of 20 mm, and disc shaped samples are prepared by pressing this powder with a force of 6,000 kgf/m² for 1 min. The average resistance value of this sample is measured five (5) times using a 2-probe method.

TABLE 1

| | | Examples | | | Comparative Examples | |
|---|---|---|---|---|---|---|
| | | 1 | 2 | 3 | 1 | 2 |
| Metal catalyst | Fe:Co:Mo:Mn | 1:3:0:3 | 1:3:0.5:0.1 | 1:3:0.5:3 | 1:3:0:0 | 1:3:0.5:0 |
| Metal catalysts:mole ratio of supports | | 1:12 | | | | |
| CNT yield of supported catalyst | | 70 | 50 | 80 | 13 | 20 |
| CNT physical | ID/IG | 0.94 | 1.08 | 0.89 | 1.41 | 1.22 |
| property | Surface resistance Ω | 0.46 | 0.50 | 0.45 | 0.60 | 0.55 |

Examples 1 to 3 include manganese, and Examples 2 to 3 further include molybdenum activator (Mo).

With regard to Raman spectrographic analysis, for typical graphite crystals, peaks near the D mode represent defects inside the crystal, whereas peaks near the G mode are common characteristic peaks appearing in typical graphite materials, indicating that hexagon carbon atoms are vibrating in opposite directions with respect to each other. This means the index presenting a hexagonal crystalline structure is well aligned without any defect. Therefore, if the IG value is relatively larger than the ID value, the (ID/IG) ratio measurement can indicate quality of the crystallinity of the material.

It is desirable if the peaks in G mode (IG) appear relatively larger than the peaks in D mode (ID) in multi-walled carbon nanotubes prepared using the supported catalysts of the invention including manganese (Mn).

With regard to the results of the Raman spectroscopic analysis, Examples 1-3 of the invention have relatively larger peaks in the G mode than peaks in the D mode. A relatively low ID/IG value means smaller ID and larger IG values, indicating that the carbon nanotubes prepared in Examples 1-3 in accordance with the invention have a well aligned hexagonal crystalline structure without any defect as compared with the carbon nanotubes of Comparative Examples 1-2.

It is also noted that the Raman spectroscopy results for Examples 1-3 do not include peaks in RBM-mode that are characteristic of single-walled or double-walled carbon nanotubes. This confirms that the carbon nanotubes of Examples 1-3 are multi-walled carbon nanotubes.

The carbon nanotubes of Examples 1-3 of the invention exhibit improved surface crystallinity and also the Bulk Surface Resistivity (Ohm/sq.) of the nanotubes is lower and they have excellent electrical conductivity.

Thus the multi-wall carbon nanotubes in accordance with this invention can have improved surface crystallinity and also excellent electrical conductivity. In exemplary embodiments, the multi-wall carbon nanotubes can also have a bulk surface resistivity of less than 0.5 Ohm/sq. cm.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A supported catalyst for synthesizing multi-walled carbon nanotubes including a supporting body and a metal catalyst comprising Fe, Co, and Mn supported on the supporting body, wherein the metal catalyst includes Fe, Co, and Mn in a mole ratio according to Equation (1) below:
Fe:Co:Mn=1:x:y (1),
wherein x and y are mole ratios and 2.0≦x≦4.0 and 0.01≦y≦5.0.

2. A supported catalyst for synthesizing multi-walled carbon nanotubes including a supporting body and a metal catalyst comprising Fe, Co, Mn, and Mo supported on the supporting body, wherein the metal catalyst includes Fe, Co, Mn, and Mo in a mole ratio according to Equation (2) below:
Fe:Co:Mn:Mo=1:x:y:z (2),
wherein x, y, and z are mole ratios and 2.0≦x≦4.0, 0.01≦y≦5.0 and 0≦z≦2.0.

3. The supported catalyst of claim 1, wherein said metal catalysts are hydrates of Fe, Co, and Mn, and said supporting body includes Al₂O₃, MgO, SiO₂, or a combination thereof.

4. The supported catalyst of claim 2, wherein said metal catalysts are hydrates of Fe, Co, and Mn, and said supporting body includes Al₂O₃, MgO, SiO₂, or a combination thereof.

5. A supported catalyst for synthesizing multi-wall carbon nanotubes including a supporting body and a metal catalyst comprising Fe, Co, Mn, Mo, and V supported on the supporting body, wherein the metal catalyst includes Fe, Co, Mn, Mo, and V in a mole ratio according to Equation (3) below:
(Fe,Co,Mn)ₓ(Mo, V)_{y}(Al2O₃,MgO,SiO₂)_{z} (3),
wherein x, y, and z mole ratios and 1≦x≦10, 0≦y≦5, and 1≦z≦20; wherein (Fe, Co, Mn) includes at least one catalyst selected from Fe, Co, and Mn; (Mo, V) includes at least one catalyst selected from Mo and V; and (Al₂O₃, MgO, SiO₂) includes at least one support body material selected from Al₂O₃, MgO, and SiO₂.

6. The supported catalyst of claim 1, wherein said supported catalyst has a solid spherical structure with an average diameter of about 20 to about 100 μm, and a degree of flatness of about 0 to about 0.2.

7. The supported catalyst of claim 2, wherein said supported catalyst has a solid spherical structure with an average diameter of about 20 to about 100 μm, and a degree of flatness of about 0 to about 0.2.

8. The supported catalyst of claim 5, wherein said supported catalyst has a solid spherical structure with an average diameter of about 20 to about 100 μm, and a degree of flatness of about 0 to about 0.2.

9. A method of preparing a supported catalyst for synthesizing multi-walled carbon nanotubes including the steps of:
preparing an aqueous solution of metal catalyst by dissolving metal catalysts comprising Fe, Co, and Mn in a solvent;
preparing an aqueous solution of a supporting body material by dissolving aluminum oxide, magnesium oxide, silicon dioxide or a combination thereof in a solvent;
mixing said aqueous solution of the metal catalyst and said aqueous solution of said supporting body material, and
heating the mixture at a temperature of about 100 to about 800° C. under normal atmospheric pressure for about 10 to about 40 min.

10. The method of claim 9, wherein the solvent is water, alcohol, or a combination thereof; and citric acid is further included as an activator in said aqueous solution of the supporting body material.

11. A method of preparing a supported catalyst for synthesizing multi-walled carbon nanotubes including the steps of:
preparing an aqueous solution of metal catalyst by dissolving metal catalysts comprising Fe, Co, Mn, and Mo in a solvent;
preparing an aqueous solution of a supporting body material by dissolving aluminum oxide, magnesium oxide, silicon dioxide or a combination thereof in a solvent;
mixing said aqueous solution of the metal catalyst and said aqueous solution of said supporting body material, and
heating the mixture at a temperature of about 100 to about 800° C. under normal atmospheric pressure for about 10 to about 40 min.

12. A method of preparing a supported catalyst for synthesizing multi-walled carbon nanotubes including the steps of:
preparing an aqueous solution of metal catalyst by dissolving metal catalysts comprising Fe, Co, Mn, Mo, and V in a solvent;
preparing an aqueous solution of a supporting body material by dissolving aluminum oxide, magnesium oxide, silicon dioxide or a combination thereof in a solvent;
mixing said aqueous solution of the metal catalyst and said aqueous solution of said supporting body material, and
heating the mixture at a temperature of about 100 to about 800° C. under normal atmospheric pressure for about 10 to about 40 min.

13. A method of preparing multi-walled carbon nanotubes comprising placing the supported catalyst of claim 1 in thermal chemical vapor deposition (TCVD) equipment and feeding hydrocarbon gas and hydrogen gas at a temperature of about 650 to about 1,100° C. under normal atmospheric pressure.

14. The method of claim 13, wherein said hydrocarbon gas is methane, ethylene, acetylene, LPG, or a combination thereof.

15. The method of claim 13, wherein the hydrocarbon gas and hydrogen gas are supplied for a period of about 30 minutes to about 1 hour, and said hydrocarbon and hydrogen gas each are supplied at a flow rate of about 80 to about 300 sccm.

16. Multi-walled carbon nanotubes prepared by the method of claim 9.

17. Multi-walled carbon nanotubes prepared by the method of claim 10.

18. Multi-walled carbon nanotubes prepared by the method of claim 11.

19. The multi-walled carbon nanotubes of claim 16, wherein said multi-walled carbon nanotubes have a surface resistance value less than 0.5 Ohm/sq. cm.
